(19) United States
(12) Patent Application Publication
(10) Pub. No.: US 2015/0254803 A1
(43) Pub. Date: Sep. 10, 2015

(54) PROCESS FOR TRUE-TO-SCALE SCALING OF A RECORDING OF A CAMERA SENSOR

(71) Applicant: AUDI AG, Ingolstadt (DE)

(72) Inventors: Andreas Schindler, Ingolstadt (DE); Christoph Gohrle, Ingolstadt (DE); Oliver Sawodny, Stuttgart (DE)

(73) Assignee: AUDI AG, Ingolstadt (DE)

(21) Appl. No.: 14/638,663

(22) Filed: Mar. 4, 2015

(30) Foreign Application Priority Data
Mar. 5, 2014 (DE) 10 2014 003 221.3

(51) Int. Cl. G06T 3/40; H04N 7/18; B60R 1/00

(52) U.S. Cl. CPC G06T 3/40; B60R 1/00; H04N 7/183

(57) ABSTRACT

A method for true-to-scale scaling of a map includes creating the map by a recording an image with a camera sensor installed on a vehicle, providing a reference variable with a true-to-scale sensor, and scaling the map with the reference variable. A system with a camera sensor, a true-to-scale sensor and a computing unit as well as vehicle using this system for true-to-scale scaling of a map are also disclosed.

### CROSS-REFERENCES TO RELATED APPLICATIONS

This application claims the priority of German Patent Application, Serial No. 10 2014 003 221.3, filed Mar. 5, 2014, pursuant to 35 U.S.C. 119(a)-(d), the content of which is incorporated herein by reference in its entirety as if fully set forth herein.

### BACKGROUND OF THE INVENTION

The present invention relates to a method for true-to-scale scaling of a recording of a camera sensor and a corresponding vehicle with a camera sensor, at least one true-to-scale sensor and a computing unit.

The following discussion of related art is provided to assist the reader in understanding the advantages of the invention, and is not to be construed as an admission that this related art is prior art to this invention.

Camera sensors are frequently employed in vehicles, wherein the cameras are used to detect an environment of a respective vehicle and possibly also for further calculations and/or services. Disadvantageously however, camera sensors typically do not reproduce a particular environment true-to-scale, i.e. with correct mutual dimensional proportions of respective objects located in the environment. For example, a model car on a model roadway may produce a similar impression as a corresponding motor vehicle on a real roadway of public road traffic. One way to distinguish such geometric conditions is by determining depth information.

To determine the depth information of a particular environment, methods disclosed in the prior art are based on a three-dimensional measurement of a respective environment.

To determine a metrological signal with a single camera or with a single camera sensor, i.e. with a mono camera, a metrological variable, such as a camera height or a vehicle speed, is frequently used. if the metrological variable, for example the vehicle speed, is off by for example 10%, all values converted with metrological variable are also off by 10%. A mono camera has, as opposed to a stereo camera, only a single image sensor and is thus incapable of calculating depth information without additional environmental details.

It would therefore be desirable and advantageous to address this problem and to obviate other prior art shortcomings by proposing a method for true-to-scale scaling of a recording of a camera sensor and a corresponding vehicle with a camera sensor, at least one true-to-scale sensor and a computing unit.

### SUMMARY OF THE INVENTION

According to one aspect of the present invention, a method for true-to-scale scaling of a map includes creating the map by a recording an image with a camera sensor installed on a vehicle, providing a reference variable with a true-to-scale sensor, and scaling the map with the reference variable.

Accordingly, the present invention relates to a method for effectively and purposely combining a true-to-scale sensor which provides true-to-scale measurements of distances of a respective environment in a metrological system with a camera sensor which measures the respective environment without attention to scale.

For a combination of respective sensors or sensor data, a discrete map of a respective environment, for example a roadway, is created and shifted according to a current vehicle speed so that there is always a projection of, for example, −15 to +15 m around a particular vehicle.

A map in the context of the present invention is to be understood as a representation of data captured by a sensor in a coordinate system, wherein the map is preferably created in a two-dimensional coordinate system. However, a pre-existing map can also be merged into a current map with data from a sensor.

According to an advantageous feature of the present invention, a signal or an image of the respective environment that was captured by the camera sensor and that is off by a certain factor in scale, may be corrected with a reference variable based on the true-to-scale sensor. For this purpose, the reference value is adjusted, for example multiplied, for example as a co-factor with respective measured values of the camera sensor.

The term reference variable in the context of the present invention is to be understood as any measure for calculating a true-to-scale scaling, especially a distance to a target object.

In order to reconcile measured values obtained with the camera sensor without attention to scale with measured values of the true-to-scale sensor, is contemplated to convert, in a first step, the measured values or data captured with the true-to-scale sensor and to determine corresponding coordinates relative to a reference line and to enter the determined coordinates in the map. In a second step, the data captured by the camera sensor are adapted to a current position of the vehicle, for example through multiplication by a factor. Subsequently, the measured values detected by the camera sensor are scaled, i.e. adjusted with various factors, until a quality measure, for example a squared difference between an elevation profile generated from the data of the camera sensor and an elevation profile generated from the data of the true-to-scale sensor is a minimum. If a significant improvement is attained with the scaling, i.e. a smaller square difference, then the values resulting from the respective scaling are to be used for merging the data from the respective sensors, i.e., to be provided for calculating a weighted average between the measured values from the respective sensors.

According to another advantageous feature according to the present invention, a pulsed laser may be selected as a true-to-scale sensor.

Lasers have been proven in the past as suitable devices for detecting distances; they are sturdy and reliable, and allow measurement in a time frame that is suitable for the method according to the invention. Distances can be measured by using a solid-state laser or a diode laser, for example, via transit time measurement or via a respective phase position of the respective laser.

When using a pulsed laser in a transit time measurement, a light pulse is emitted and the time for the light pulse to be reflected from a target is measured. By measuring this time, i.e. the so-called “transit time”, a distance between the laser and the target reflecting the light pulse can be determined as a function of the speed of light and the “transit time”. An advantage of a transit time measurement is its short response time.

According to another advantageous feature of the present invention, in order to adjust the map to respective reference values obtained with the true-to-scale sensor, i.e. to include measurement values from the true-to-scale sensor in the map, the measured values may be plotted in the map in relation to a reference line, so that the map and/or respective measured values from the camera sensor used for generating the map can be corrected, if necessary.

According to another advantageous feature of the present invention, the reference, line used to draw the respective related measured values from the respective sensors may be a reference line fixed in relation to the sensor.

A reference line fixed in relation to the sensor in the context of the present invention is to be understood as representing a reference line that is fixedly arranged on or applied to a respective sensor, for example for calibration purposes.

According to another advantageous feature of the present invention, the reference line may be determined by way of a least-square fit of measured values from the true-to-scale sensor.

To adapt a reference line to be used for relating respective values from the respective sensors to respective conditions or circumstances, the reference line may advantageously be formed by a least-square-fit from measured values from at least one sensor. Confounding variables may possibly be considered and compensated when forming the reference line by taking into account currently determined values from at least one sensor.

According to another advantageous feature of the present invention, the map and respective actual measured values may be shifted as a function of a respective vehicle movement.

To adapt respective measured values to a modified vehicle position, it is imperative that the measured values used to generate the map are adjusted with a factor, for example a longitudinal and/or transverse coordinate and a vehicle speed, so that the map and/or the respective current measured values are always matched to a current position of the respective vehicle and are thus available in a fixed vehicle coordinate system.

According to another advantageous feature of the present invention, a model may be fitted to both in the map and in respective measured values of the camera sensor and the true-to-scale sensor, wherein respective parameters of the model are changed such that curves obtained from the model fitted to the measured values as well as from the model fitted in the map are as congruent as possible.

To avoid possible multiple rescaling with corresponding scaling factors and related, possibly repeated tests or tries, a model, such as a polynomial, may be used which is fitted to a respective map, and in particular measured values from the camera sensor and/or from the true-to-scale sensor. To this end, these respective parameters of the model are changed so that respective curves of the model of the map or the respective measured values are as congruent as possible with one another. Such overlap can be calculated, for example, by using an optimization problem wherein a system of linear equations is solved to determine respective parameters. If a significant improvement can be expected by using the model, or from a calculation using the model, then a respective signal, i.e. measured values from the sensors, can be averaged or accumulated with the map, based on the calculated scaling of parameters of the map, in order to increase the accuracy of a respective measurement and/or to minimize sensor noise. If no significant improvement is achieved with the scaling, then the respective original map parameters may be kept.

The present invention also relates to a vehicle, a camera sensor and at least one true-to-scale sensor and a computing unit, wherein the computing unit is configured to create a map based on respective measured values from the camera sensor and to shift the map as a function of a current vehicle speed, as well as to scale the map true-to-scale by reconciling the measured values from the camera sensor with measured values from the at least one true-to-scale sensor.

The vehicle according to the invention is used in particular for applying the method according to the invention and allows an accurate true-to-scale orientation in a respective environment by way of a camera sensor and a laser.

The laser can be arranged at any technically suitable position in or on the vehicle according to the invention, in particular in an engine hood or on a side part, such as a rearview mirror or a door.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an exemplary embodiment of merging data from a mono camera with data from a true-to-scale sensor according to the present invention;

FIG. 2 shows an exemplary embodiment of the vehicle according to the present invention with a mono camera and a true-to-scale sensor; and

FIG. 3 shows an elevation map with measured values from a camera sensor and measured values from a true-to-scale sensor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

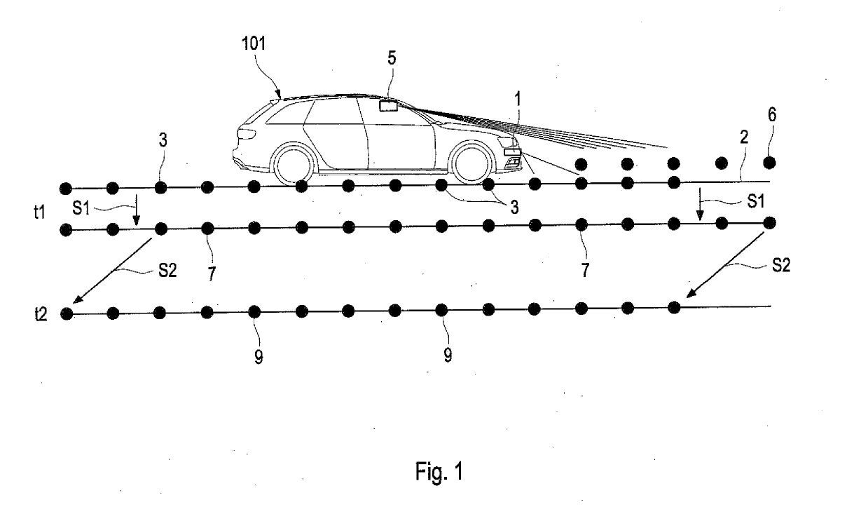

Turning now to the drawing, and in particular to FIG. 1, there is shown a process flow of the method according to the invention in a vehicle 101. At a step S1 and at a time t1, respective mono data 6 are collected, for example, from a mono camera 5 arranged in a vehicle to create a map are merged with measured data 3 from a laser 1, which were aligned with a sensor-fixed reference line 2, into scaled values 7, and thereafter, at a step S2 and at a time t2, shifted relative to a current position of the vehicle 101.

To scale respective mono data 6 from the map of the current environment with measured data 3 from the laser 1 and to thereby obtain a true-to-scale map, for example an elevation map of a current surroundings of the vehicle 101, the mono data 6, which may have been recorded with a time delay in relation to the measured data 3 from the laser 1, must if necessary be adjusted. For this purpose, the mono data 6 may, for example, be scaled until a difference of squares between mono data 6 and measured data 3 is a minimum. It is continuously checked whether a significant improvement results from the scaling, i.e. whether the difference between mono data 6 and the measured data 3 becomes smaller. If a significant improvement is achieved, i.e. when the difference becomes smaller, then the scaled and adapted mono data 6 are merged with measured data 3 from the laser 1 into scaled values 7, for example averaged.

A further possibility for merging measured data 3 from the laser 1 and mono data 6 from the mono camera 5 is offered by a model, such as a polynomial, which is adapted to both the measured data 3 from the laser 1 and the mono data 6 from the mono camera 5. The respective parameters of the model are adjusted so that corresponding curves of the model for measured data 3 and mono data 6 provide the best possible fit. For example, an optimization problem may be used for this purpose wherein, for example, a system of linear equations is solved.

For adapting the scaled values 7 to a speed of the vehicle 101, the scaled values 7 are continuously updated, i.e. data collected at a time t1 by the mono camera 5 or the laser 1, for example, are shifted at a second step S2, for example as a function of a current vehicle speed, so that corresponding shifted and scaled values 9 are at a time t2 located in a defined area around the vehicle 101. Respective scaled and shifted values 9 that are for example shifted horizontally and are no longer located inside the defined range will be deleted.

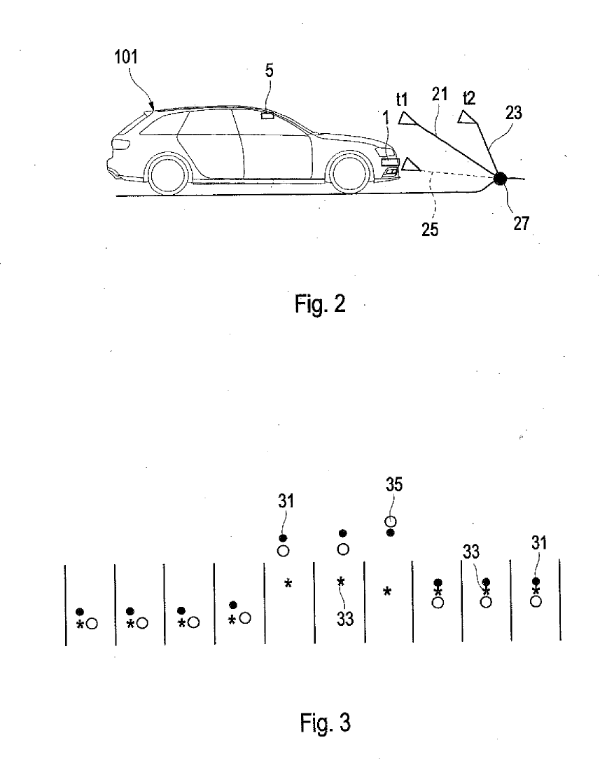

The diagram of the vehicle 101 shown in FIG. 2 with the installed mono camera 5 indicates by the solid lines 21 and 23 a distance measurement by the mono camera 5 without attention to scale at respective times t1 and t2. The laser 1 also arranged on the vehicle 101 supplies, as indicated by the dashed line 25, a continuously updated true-to-scale measurement of a respective distance to an object 27, for example in a metrological system. Since a true-to-scale distance measurement is not possible when using only a recording from the mono camera 5, a map determined with the mono camera 5 is scaled, i.e. merged, using the true-to-scale measured values from the laser 1. The laser 1 is able to measure distances very accurately with a transit time measurement of a light pulse generated by the laser 1.

Based on a distance defined by the laser 1, for example in the metrological system, the map determined by the mono camera 5 can be scaled true-to-scale.

By merging the measured values from the two sensors, a true-to-scale map of a respective environment can be generated and provided to a driver.

The sensor values from the two sensors “mono camera 5” and “laser 1” can be merged selectively either via a weighted average of the respective sensor values or by using a suitable model. When using a model, a mathematical model, such as a polynomial, is first fitted to the map based on mono data 6 from the mono camera 5 and then to the measured data 3 from the laser 1; thereafter, respective parameters of the model are changed so that curves resulting from the model for sensor values from the mono camera 5 and the laser 1 are as congruent as possible. In order to bring the respective curves into overlapping relationship, for example, an optimization problem can be solved with a system of linear equations, so that respective parameters of the model can be determined.

FIG. 3 shows an elevation map, in which data points 31 collected from the laser 1 are plotted. Data points 33 determined by the mono camera 5 are rotated and shifted vertically until they match the map. These are then scaled to data points 35 until they produce the best fit with the already created map, i.e. they best fit depth information determined by the laser 1. To minimize sensor noise of the respective sensors, the respective data points may advantageously be accumulated and averaged.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for true-to-scale scaling of a map, comprising:
creating the map by a recording an image with a camera sensor installed on a vehicle;
providing a reference variable with a true-to-scale sensor; and
scaling the map with the reference variable.

2. The method of claim 1, wherein the true-to-scale sensor is a pulsed laser.

3. The method of claim 1, wherein the map is created of an area in front and behind the vehicle, the method further comprising:
shifting the map in dependence of a current vehicle speed;
converting measured values determined by the true-to-scale sensor into coordinates; and
recording the coordinates on the map in relation to a reference line.

4. The method of claim 3, wherein the reference line is fixed in relation to the true-to-scale sensor.

5. The method of claim 3, wherein the reference line is determined by a least-square error fit of the measured values from the true-to-scale sensor.

6. The method of claim 1, wherein the map and current measured values are shifted in dependence of a respective vehicle movement.

7. The method of claim 1, wherein the map is scaled until a quality measure based on a match between sensor data from the camera sensor and data from the true-to-scale sensor is minimized.

8. The method of claim 7, wherein the quality measure is a squared difference of sensor data from the camera sensor and from the true-to-scale sensor.

9. The method of claim 1, further comprising:
fitting a model to the map based on measured values from the camera sensor and to measured values from the true-to-scale sensor, and
changing parameters of the model so that curves resulting from the measured values from the camera sensor and from the measured values from the true-to-scale sensor have a greatest possible overlap.

10. A vehicle comprising:
a camera sensor,
at least one true-to-scale sensor, and
a computing unit configured to
create a map based on measured values from the camera sensor,
shift the map in dependence of a current vehicle speed,
reconcile the map by matching measured values from the camera sensor with measured values from the at least one true-to-scale sensor, and
scale the map true-to-scale.

11. A system comprising:
a camera sensor,
at least one true-to-scale sensor, and
a computing unit configured to
create a map based on measured values from the camera sensor,
shift the map in dependence of a current vehicle speed,
reconcile the map by matching measured values from the camera sensor with measured values from the at least one true-to-scale sensor, and
scale the map true-to-scale.
